(19) United States
(12) Patent Application Publication
(10) Pub. No.: US 2024/0059913 A1
(43) Pub. Date: Feb. 22, 2024

(54) POWDER COATING COMPOSITION

(71) Applicants: THE CHEMOURS COMPANY FC, LLC, WILMINGTON, DE (US); CHEMOURS-MITSUI FLUOROPRODUCTS CO., LTD., TOKYO (JP)

(72) Inventors: RYO NAKAZAWA, SHIZUOKA (JP); MASAHIRO TAKEYAMA, SHUZUOKA (JP); HOAI-NAM PHAM, SHIZUOKA (JP); SHUTARO KAMEYAMA, SHIZUOKA (JP)

(73) Assignees: THE CHEMOURS COMPANY FC, LLC, WILMINGTON, DE (US); CHEMOURS-MITSUI FLUOROPRODUCTS CO., LTD, TOKYO (JP)

(21) Appl. No.: 18/278,026

(22) PCT Filed: Feb. 22, 2022
(86) PCT No.: PCT/US2022/017189

§ 371 Date: Aug. 21, 2023

(30) Foreign Application Priority Data
Feb. 22, 2021 (JP) 2021-026033

(51) Int. Cl. C09D 7/61; C09D 5/03; C09D 127/18

(52) U.S. Cl. CPC C09D 7/61; C09D 5/034; C09D 5/031; C09D 127/18; C08K 3/042

(57) ABSTRACT

An object of the present invention is to provide a hot-melt fluorine resin powder coating composition containing a filler, which has a large film thickness that can be coated once, a large limit film thickness for an overcoating, and can be thickly coated.

The present invention is a powder coating composition, which is a powder mixture, containing: first hot-melt fluorine resin particles having an average particle diameter of 2 to 100 μm in which a filler is dispersed in the particles; second hot-melt fluorine resin particles having an average particle diameter of 10 to 200 μm; and charge controlling agent particles.

### CROSS REFERENCE TO RELATED APPLICATIONS

This application is a national filing under 35 U.S.C. 371 of International Application No. PCT/US2022/017189 filed Feb. 22, 2022 and claims the benefit of priority of Japanese Application No. 2021-26033 filed Feb. 22, 2021, the disclosure of which is incorporated herein by reference in its entirety.

### TECHNICAL FIELD

The present invention relates to a hot-melt fluorine resin powder coating composition containing a filler, which can be thickly coated on a vertical surface by electrostatic powder coating.

### BACKGROUND TECHNOLOGY

Fluorine resins have excellent heat resistance, chemical resistance, electrical properties, and mechanical properties in addition to having a very low coefficient of friction and tack-free properties, leading to widespread use in all types of industrial fields such as chemistry, machinery, electrical devices, and the like. In particular, hot-melt fluorine resins demonstrate liquidity at temperatures above a melting point, and therefore, the generation of pin holes can be suppressed when formed in a coating, thereby allowing the fluorine resins to be used in coating compositions for fluorine resin coatings.

Patent Document 1 discloses an aqueous liquid coating of a fluorine resin. These aqueous liquid coatings are used as so-called slurry coatings with high concentration and viscosity, allowing for a thick coating. However, slurries coatings are prone to foaming when a solvent (dispersion medium) volatilizes, as opposed to powder coatings. In order to prevent this, various solvents are used and a multistage baking and drying process is required, resulting in environmental problems such as solvent volatilization, a longer time for a slurry to dry, and more difficult storage and management of a slurry than powder coating, difficulty in coating a material to be coated with complex shapes with a slurry, and the like.

On the other hand, hot-melt fluorine resin powder coatings have advantages where thick coating is possible without a volatile liquid medium, the coating can be reused, and no VOC (volatile organic compound) is generated. Electrostatic coating is commonly used as a method of powder coating using a hot-melt fluorine resin powder coating, in which a material to be coated and a powder coating are charged and coated. Furthermore, when a filler is used to impart various properties such as conductivity, wear resistance, abrasion resistance, and the like to the hot-melt fluorine resin powder coating, or to adjust the appearance such as the color, brilliant look, and the like, particles of the hot-melt fluorine resin powder coating and filler can be mixed and used. However, the particles of the filler are preferably dispersed in the hot-melt fluorine resin powder particles from the perspective of thick coatability, coating film durability, preventing of desorption of the filler from the coating film, preventing variations in the coating film, and the like (for example, Patent Documents 2 and 3).

On the other hand, in recent years, durability and corrosion resistance of coating films have tended to be required, and thick coating is required to be possible in order to improve productivity and reduce processing cost. Furthermore, in order to improve productivity, a film thickness that can be obtained in one coating is preferably larger in order to reduce the number of times of overcoating. However, a hot-melt fluorine resin powder coating containing a filler, and particularly a conductive filler, have inferior thick coatability as compared to those without a filler. It is believed that this is because even if the filler is internally dispersed as described above, including a conductive filler makes it difficult to apply an electric charge to the powder particles in electrostatic coating, therefore, the particles are easily desorbed. On the other hand, the conductive coating is used to prevent electrification, but there is also a demand for a thick coating to provide corrosion resistance. Furthermore, thus far, conductive coatings often provided conductivity only to a surface layer, but there is demand to provide conductivity to an entire thick coating film.

And, a hot-melt fluorine resin powder coating such as PFA and the like is known to be capable of thick coating as compared to a liquid coating. Although a thicker coating is possible by a Rotolining method, a target of use is limited to an inner surface of structures with a circular cross section of a tank or pipe, where Rotolining can be applied (Non-Patent Document 1).

### PRIOR ART DOCUMENTS

Patent Document 1: Japanese Patent Publication 3321805
Patent Document 2: Japanese Published Examined Application H5-73147
Patent Document 3: Japanese Published Examined Application S52-44576

### Non-Patent Documents

Non-Patent Document 1: Corrosion-Resistant Lining and Coating Guidebook (published by JAPAN FLUOROPOLYMERS INDUSTRY ASSOCIATION), p. 9, Table 1

### SUMMARY OF THE INVENTION

### Problem to Be Resolved by the Invention

An object of the present invention is to provide a hot-melt fluorine resin powder coating composition containing a filler, having a high film thickness that can be coated once and a high limit film thickness for an overcoating, that can be thickly coated.

### Means for Resolving Problems

The present invention is a powder coating composition, which is a powder mixture, containing: first hot-melt fluorine resin particles having an average particle diameter of 2 to 100 μm in which a filler is dispersed in the particles; second hot-melt fluorine resin particles having an average particle diameter of 10 to 200 μm; and charge controlling agent particles.

In the powder coating composition of the present invention, the ratio of the first hot-melt fluorine resin particles to the second hot-melt fluorine resin particles is preferably 1 to 60:40 to 99 wt %, and the amount of charge controlling agent particles are in 0.01 to 5 wt % of the total amount of the powder coating composition. The average particle diameter of the second hot-melt fluorine resin particles is preferably larger than the average particle diameter of the first hot-melt fluorine resin particles. Furthermore, the filler is preferably a conductive filler, and the conductive filler is more preferably a carbon material having a graphene structure. Furthermore, the charge controlling agent particles are preferably graphite. Furthermore, the hot-melt fluorine resin is preferably a perfluoro resin.

Another aspect of the present invention is a coating film manufactured from the powder coating composition, and the film thickness is preferably 100 μm or more.

### Effect of the Invention

The present invention provides a hot-melt fluorine resin powder coating composition containing a filler, which has a large film thickness that can be coated once, has a large limit film thickness for an overcoating and can be thickly coated.

### DESCRIPTION OF THE PREFERRED EMBODIMENTS

The powder coating composition of the present invention is a powder coating composition, which is a powder mixture containing (1) first hot-melt fluorine resin particles, (2) second hot-melt fluorine resin particles, and (3) charge controlling agent particles.

### (1) First Hot-Melt Fluorine Resin Particles

The first hot-melt fluorine resin particles are described below. The first hot-melt fluorine resin particles of the present invention are particles having an average particle diameter of 2 to 100 μm, in which a filler is dispersed in a hot-melt fluorine resin, and is manufactured from the hot-melt fluorine resin and the filler.

The hot-melt fluorine resin used in the present invention may be appropriately selected from resins known as hot-melt fluorine resins. Examples include polymers or copolymers of a monomer selected from tetrafluoroethylene, chlorotrifluoroethylene, hexafluoropropylene, perfluoro(alkyl vinyl ether), vinylidene fluoride and vinyl fluoride, copolymers of the monomers and ethylene, propylene, butylene, pentene, hexene, or another monomer having a double bond, or acetylene, propine, or another monomer having a triple bond, and the like. Specific examples of the hot-melt fluorine resin include low molecular weight hot-melt polytetrafluoroethylenes (hot-melt PTFE), tetrafluoroethylene perfluoro(alkyl vinyl ether) copolymers (PFA), tetrafluoroethylene hexafluoropropylene copolymers (FEP), tetrafluoroethylene hexafluoropropylene perfluoro (alkyl vinyl ether) copolymers, tetrafluoroethylene ethylene copolymers, polyvinylidene fluorides, polychlorotrifluoroethylenes, chlorotrifluoroethylene ethylene copolymers, and the like.

Of these hot-melt fluorine resins, perfluoro resins such as hot-melt PTFE, PFA and FEP, tetrafluoroethylene, hexafluoropropylene and perfluoro(alkyl vinyl ether) copolymers are particularly preferably used from the perspective of tack-free properties and heat resistance of a coating film. Of these, PFA is preferable from the perspective of heat resistance. When PFA is used, an alkyl group of the perfluoro(alkyl vinyl ether) in the PFA preferably have 1 to 5 carbon atoms, and more preferably 1 to 3 carbon atoms. Furthermore, the amount of the perfluoro(alkyl vinyl ether) in the PFA is preferably within a range of 1 to 50 wt %.

Furthermore, the hot-melt fluorine resin used in the present invention is preferably a hot-melt fluorine resin having fluidity at a temperature above the melting point, from the perspective of favorable moldability during high temperature melting. Specifically, the melt flow rate (MFR) of the hot-melt fluorine resin is preferably 0.1 g/10 min or more, and more preferably 0.5 g/10 min or more. Examples of the resin include PFA, FEP, and tetrafluoroethylene, hexafluoropropylene, and perfluoro(alkyl vinyl ether) copolymers. PFA, which has a high melting point and excellent thermal fluidity, is particularly preferable. On the other hand, if the MFR is too high (melt viscosity is too low), appearance defects due to sagging or shrinking (sink mark) may easily occur during repeated coating and baking, and formation of a thick film becomes difficult, which is not preferable. Specifically, the MFR of the hot-melt fluorine resin is preferably 15 g/10 min or less, more preferably 10 g/10 min or less, and particularly preferably 5 g/10 min or less.

The hot-melt fluorine resin used in the present invention may be mixed with two or more hot-melt fluorine resins depending on the properties desired. Furthermore, a non-hot-melt polytetrafluoroethylene may also be included.

In the first hot-melt fluorine resin particles of the present invention, the filler is dispersed inside the particles. Herein, the filler material is preferably dispersed uniformly inside the particles. Whether or not the filler is uniformly dispersed within the particles can be confirmed by observing the surface of the particles with an electron microscope or the like to ensure that the filler is uniformly dispersed. Furthermore, although it depends on the physical properties of the filler used, when a conductive filler is used, confirmation is possible by measuring the volume resistivity. The volume resistivity is a value measured in accordance with a measuring method (7) described in the specification, and when a conductive filler is used, the volume resistivity is preferably 106 Ω·cm or less. Thus, in order to uniformly disperse the filler in the hot-melt fluorine resin to manufacture resin particles, a method described in Patent Document 2 can be used, for example.

Various types of fillers can be used as the filler dispersed in the particles. Examples include metal powders, metal oxides (aluminum oxide, zinc oxide, tin oxide, titanium oxide, and the like), glass, ceramics, silicon carbides (SiC), silicon oxides, boron nitrides, calcium fluorides, carbon black, graphites, micas, barium sulfates, various resin particles, and the like. Fillers having a variety of shapes, such as particle shaped, fiber shaped, flaked shaped fillers, and the like, can be used.

In particular, the present invention is effective when using a conductive filler, and examples of the conductive filler include metals, metal oxides (zinc oxides, tin oxides, titanium oxides, indium oxides, and the like), titanium carbides, titanium nitrides, carbon fibers, carbon black, graphite, carbon nanotubes (CNT), and other carbon materials having a graphene structure, particles coated therewith, and composite particles. In order to achieve high conductivity, a combination of carbon black and carbon fiber is preferably used. Furthermore, in the present invention, a material having relatively low insulating properties such as silicon carbide (SiC), and particularly, having a volume resistivity of 108 Ω·cm or less, can also be used as the conductive filler. Silicon carbide (SiC) is preferably used in order to improve the wear resistance of the coating film.

Furthermore, thick coating is difficult when polar particles with hydrophilic surfaces such as mica, aluminum oxide, boron nitride, and silicon oxide are used (the electrical properties of the fluorine resin and the filler are different, and therefore, variations in charging during electrostatic coating are thought to occur), but such a filler can be used. Mica can provide a brilliant look to the coating film and is therefore preferably used.

Fillers having a variety of shapes, such as particle shaped, fiber shaped, flaked shaped fillers, and the like, can be used as the shape of the particles. A preferred mixing amount depends on the properties required and the type of filler and size of the particles, but is preferably 0.1 to 30 wt %, more preferably 1 to 10 wt %, and particularly preferably 2 to 5 wt %. If the amount of filler is low, the effect of the filler is reduced. Furthermore, if the amount of filler is high, there is a concern that a smooth and uniform coating film cannot be obtained due to easy aggregation of filler particles or high melt viscosity.

The average particle diameter of the first hot-melt fluorine resin particles is within a range of 2 to 100 μm, preferably 3 to 75 μm, more preferably 5 to 50 μm, and particularly preferably 8 to 35 μm. If the average particle diameter is small, not only is electrostatic powder coating difficult due to the effects of wind, but manufacturing is difficult in the first place and aggregation tends to occur during storage, causing defects. Furthermore, if the average particle diameter is too large, a charge is difficult to apply and thus desorption tends to occur. Therefore, electrostatic coating becomes difficult, and the surface of the obtained coating film becomes unsmooth.

Note that in the present specification, “average particle diameter” refers to the particle diameter at an integrated value of 50% of the particle diameter distribution (based on volume) obtained by laser diffraction/scattering (d50).

### (2) Second Hot-Melt Fluorine Resin Particles

The second hot-melt fluorine resin particles of the present invention are particles containing a hot-melt fluorine resin having an average particle diameter of 10 to 200 μm.

The second hot-melt fluorine resin particles can be manufactured from the resin used in the first hot-melt fluorine resin particles described above. The second hot-melt fluorine resin particles differ from the first hot-melt fluorine resin particles described above in that a filler is not included. Of hot-melt fluorine resins, perfluoro resins such as PFA and FEP, tetrafluoroethylene, hexafluoropropylene and perfluoro(alkyl vinyl ether) copolymers are particularly preferably used from the perspective of tack-free properties and heat resistance of a coating film. Of these, PFA is preferable from the perspective of heat resistance.

The average particle diameter of the particles is within a range of 10 to 200 μm, preferably 15 to 150 μm, more preferably 20 to 100 μm, and particularly preferably 25 to 70 μm. When comparing the average particle diameter with that of the first hot-melt fluorine resin particles described above, the average particle diameter of the second hot-melt fluorine resin particles is preferably larger than that of the first hot-melt fluorine resin particles. A commercially available hot-melt fluorine resin powder coating can be used. Note that the particles do not contain a filler, but may contain a small amount of an additive such as an antifoaming agent or the like outside the particles (in a powder mixed condition).

### (3) Charge Controlling Agent Particles

Various types of conductive particles can be used as the charge controlling agent particles of the present invention. Examples include metal powders, carbon fibers, carbon blacks, graphite, carbon nanotubes (CNT) and other carbon materials with a graphene structure, metal oxides (zinc oxides, tin oxides, titanium oxides, indium oxides, and the like), titanium carbides, titanium nitrides, and the like. Of these, carbon materials having a graphene structure is preferably used, and graphite is particularly preferably used. A function of the charge controlling agent particles is believed to be the charge adjusting agent particles adhering to and coating the particles where the electrostatic properties differ between the first hot-melt fluorine resin particles containing the filler and the second hot-melt fluorine resin particles not containing a filler, so as to homogenize the electrostatic properties of the surfaces and provide uniform mixing without aggregating and separating when the particles are mixed together. Herein, the reason why graphite is preferable is because dry mixing is performed at high speed, brittle graphite is pulverized to form fine sheets, which can be adhered to and coated on the particles.

### (4) Optional Components

The powder coating composition of the present invention may also contain an additive of an organic/inorganic material as an optional component within a range that does not affect the physical properties of the powder coating composition. Examples include polyarylene sulfides, polyether ether ketones, polyamides, polyimides, and other engineering plastics, metal powders, metal oxides (aluminum oxide, zinc oxide, tin oxide, titanium oxide, and the like), glass, ceramics, silicon carbides, silicon oxides, calcium fluorides, carbon black, graphites, micas, barium sulfates, and the like. Additives having a variety of shapes, such as particle shaped, fiber shaped, flaked shaped fillers, and the like, can be used as the shape of the additive. The amount is preferably 10 wt % or less, and more preferably 5 wt % or less, based on the total amount of the powder coating composition.

### (5) Composition Ratio of the Powder Coating Composition of the Present Invention

In the powder coating composition of the present invention, the ratio of the first hot-melt fluorine resin particles to the second hot-melt fluorine resin particles is preferably within a range of 1 to 60:40 to 99 wt %, more preferably 5 to 50:50 to 95 wt %, and even more preferably 10 to 45:55 to 90 wt %. Furthermore, the amount of the charge controlling agent particles is preferably in 0.01 to 5 wt % of the entire powder coating composition, more preferably in 0.1 to 3.0 wt %, and even more preferably in 0.2 to 2.0 wt %. Furthermore, the ratio of the fluorine resin in the entire powder coating composition is 80 wt % or more, and preferably 90 wt % or more. If the ratio of the fluorine resin is increased, the properties of the fluorine resin, such as releasability, slipping properties, chemical resistance, weather resistance, and the like, can be properly achieved. However, if the ratio of fluorine resin is reduced, the properties of the fluorine resin cannot be sufficiently achieved.

### (6) Manufacturing Method

A method of manufacturing the powder coating composition of the present invention is described below.

The powder coating composition of the present invention is obtained by mixing the first hot-melt fluorine resin particles, the second hot-melt fluorine resin particles, and the charge controlling agent particles. Examples of mixing methods that can be used include a method of mixing the particles in a dry condition (dry blending/dry mixing) and a fluid mixing method using a Turbula mixer or the like that stirs by rolling a container for mixing itself. Examples of devices used for dry blending include, but are not limited to, cutter mixers, Henschel mixers, V-type blenders with a chopper, double-cone mixers with a chopper, rocking mixers, and the like. The mixed resin composition is molded into a prescribed shape in accordance with the intended use.

### (7) Coating Film Prepared by the Powder Coating Composition of the Present Invention

The “coating film” of the present invention is a coating film obtained by coating the powder coating composition of the present invention. A primer layer that adheres to a substrate and contains a fluorine resin is preferably provided in order to adhere to the substrate. The method of coating the powder coating composition of the present invention can be any conventionally known powder coating method, but electrostatic powder coating is preferable. After coating, a coating film free of pinholes and other defects is obtained by heating to a temperature higher than the melting point of the hot-melt fluorine resin. The powder coating composition of the present invention can be preferably used: cookware such as frying pans, rice cookers, and the like; heat-resistant release trays in factory lines or the like (such as a bread-baking process and the like); office equipment-related products such as fixing rollers/belts/inkjet nozzles and the like; industrial equipment-related products at chemical plants such as piping and the like; and other products requiring tack-free properties and water and oil repellency.

### Preparing Aluminum Test Piece

### (A) Substrate Surface Treatment (Shot Blasting)

A surface of an aluminum substrate (JIS A1050 compliant product, 95 mm×150 mm, 1 mm thick) was degreased using isopropyl alcohol, and then a sandblaster (Numablaster SGF-4(A)S-E566, manufactured by Fuji Manufacturing Co., Ltd.) was used to roughen the surface by shot blasting using #60 alumina (Showa Blaster, manufactured by Showa Denko KK).

### (2) Undercoating (Primer Application)

An air spray coating gun (W-88-10E2 φ1 mm nozzle (manual gun), manufactured by Anest Iwata Corporation) was used to spray and coat a liquid primer coating (fluorine resin Teflon (registered trademark) coating, Aqueous primer PJ-BN910, manufactured by Chemours-Mitsui Fluoroproducts Co., Ltd.) onto the substrate treated in (A) described above at an air pressure of 3 to 4 kgf/cm². Coating was performed such that a coated liquid weight was approximately 0.9 to 1.4 g per sheet of the substrate, and then drying was performed in a forced draft circulation furnace at 120° C. for 15 minutes to form a coating film with a film thickness of 8 to 12 μm. The coating environment was temperature of 25° C. and a humidity of 60% RH.

### Evaluation Method

### (1) Coating Film Appearance

Using an electrostatic powder coating machine (Hand Gun System GX7500CS, manufactured by Nihon Parkerizing Co., Ltd.), the aluminum substrate treated in (A) and (B) above was placed horizontally in a grounded condition, and a powder was electrostatically coated at a coating voltage of 20 to 40 kV (negative) and a discharge rate of about 50 g/min from a distance of approximately 25 cm to a coating amount of approximately 2.8 g (corresponding to a film thickness of 100 μm). After baking at 390° C. for 30 minutes, the appearance of the obtained coating film was observed. Cases that were uniform and had no abnormal appearances were deemed as passed (∘).

### (2) Concealability

The appearance of the coating film obtained in the aforementioned (1) was observed to confirm whether the color of the primer was concealed. Cases where the color of the base was not visible were deemed as passed (∘).

### (3) Thick Coatability 1

Using an electrostatic powder coating machine (Hand Gun System GX7500CS, manufactured by Nihon Parkerizing Co., Ltd.), the aluminum substrate treated in (A) and (B) above was placed in a vertical condition and a grounded condition. Then, a powder was electrostatically coated at a coating voltage of 20 to 40 kV (negative) and a discharge rate of about 50 g/min from a distance of approximately 25 cm until the powder did not adhere. The coating environment was 25° C. with humidity of 60% RH. The coated aluminum substrate was baked in a forced draft circulation furnace at 390° C. for 30 minutes to form a coating film. The coating amount, presence or absence of falling powder, presence or absence of electrostatic repulsion, and the appearance of the obtained coating film were checked. Coating films with a coating amount of 2.8 g (corresponding to a film thickness of 100 μm) or more, no falling powder, no electrostatic repulsion, foaming and other defects were deemed as passed (∘).

(4) Thick Coatability 2

Using an electrostatic powder coating machine (Hand Gun System GX7500CS, manufactured by Nihon Parkerizing Co., Ltd.), electrostatic coating was performed on a horizontally installed glass substrate (float glass, 95 mm×150 mm, 2 mm thick) such that the film thickness was 100 to 120 μm each time. Baking was performed for 30 minutes at a prescribed temperature, which was repeated five times (390° C. for the first time, 360° C. for the second and third times, and 340° C. for the fourth and fifth times). Whether or not the thickness of the baked film was 500 μm or more and whether or not defects due to foaming were present were observed. If the thickness was 500 μm and defects due to foaming were not observed, the film was deemed as passed (∘).

### (5) Conductivity 1

Electrostatic coating was performed on a glass substrate (float glass, 95 mm×150 mm, 2 mm thick) such that the film thickness was 100 to 120 μm. After baking at 390° C. for 30 minutes, the coating film was peeled off in boiling water to obtain a film. A surface resistance value was measured by Hiresta UX manufactured by Nittoseiko Analytech Co., Ltd. using a UA probe at an applied voltage of 100 V. The surface resistance was indicated as passed (∘) when lower than 10⁹Ω, Δ when 10^{10 to 12}Ω, and x when higher than 10¹²Ω.

### (6) Conductivity 2

A coating film with a thickness of 300 μm or more prepared under the same conditions as in Thick coatability 2 was peeled off in boiling water to obtain a film. A surface resistance value was measured by Hiresta UX manufactured by Nittoseiko Analytech Co., Ltd. using a UA probe at an applied voltage of 100 V. The surface resistance was indicated as passed (∘) when lower than 10⁹Ω, Δ when 10^{10 to 12}Ω, and x when higher than 10¹²Ω.

### (7) Volume Resistivity

Electrostatic coating was performed on a glass substrate (float glass, 95 mm×150 mm, 2 mm thick) such that the film thickness was 50 to 100 μm. After baking at 390° C. for 30 minutes, the coating film was peeled off in boiling water to obtain a film. The film was peeled off and the volume resistivity was calculated by measuring a resistance value in a thickness direction (front surface and back surface) of the coating film using a UA probe by a Hiresta UX manufactured by Nittoseiko Analytech Co., Ltd. at an applied voltage of 100 V. If the volume resistivity was lower than 10⁶ Ω·cm, the used particles were deemed to be favorable.

### Raw Materials

Carbon black 1: “Asahi Thermal” manufactured by Asahi Carbon Co., Ltd., Average primary particle diameter: 80 nm (oil furnace black)
Carbon black 2: Carbon ECP (KETJENBLACK) manufactured by Lion Specialty Chemicals Co., Ltd., Average primary particle diameter: 25 nm.
Carbon fiber (Torayca Milled Fiber MLD-30 manufactured by Toray Industries, Inc., Average length: 30 μm)
Graphite (UF-G5 manufactured by Showa Denko KK, Average particle diameter: 3 μm)

### PFA Aqueous Dispersion

A PFA aqueous dispersion was prepared as follows. A dispersion of a tetrafluoroethylene/perfluoropropyl vinyl ether (TFE/PPVE) copolymer was prepared by a method in accordance with Examples 1 to 3 described in Japanese Patent publication 5588679. (MFR of solid resin=16.6 [g/10 min], Average particle diameter: 0.186 μm, Co-monomer (PPVE) ratio: 3.3 wt %, PFA content in dispersion: 30.6 wt %)
PFA powder coating: Fluorine Resin Teflon (registered trademark) coating powder topcoat MJ-508 manufactured by Chemours-Mitsui Fluoroproducts Co., Ltd., Average particle diameter d50: approximately 50 μm (mixture of pulverized amorphous particles and 3% PPS particles (to suppress foaming))
2H, 3H-decafluoropentane (Vertrel (registered trademark) XF manufactured by Chemours-Mitsui Fluoroproducts Co., Ltd.)
60% nitric acid (manufactured by FUJIFILM Wako Pure Chemical Corporation)
Silicon carbide (SiC) (spherical particle powder with an average particle diameter of approximately 25 μm)
Mica (IRIODIN (registered trademark) 355 manufactured by MERCK KGAA, scale-like particle powder with a particle size of 10 to 100 μm)

### EXAMPLES

### Comparative Example 1

### Preparation Example of First Hot-Melt Fluorine Resin Particles 1

1000 g of pure water was collected in a 2 L stainless steel beaker, 29.5 g of carbon black 2 (KETJENBLACK) and 9.0 g of graphite were added, and then an ultrasonic dispersion treatment was performed for five minutes using an ultrasonic generator (UE-100Z28S-8A Ultrasonic generator, manufactured by Ultrasonic Engineering Co., Ltd.). The obtained dispersion solution was further added into a stainless steel container containing 4200 g of an PFA aqueous dispersion, and stirred at 600 rpm for 3 minutes using a downflow type propeller type 4-bladed stirrer. Then, 88 g of a 60% nitric acid aqueous solution was added thereto, and after confirming a rapid increase in viscosity, 1000 g of 2H, 3H-decafluoropentane was added to generate coarse particles of aggregates in the liquid. The coarse particles of the aggregate removed by filtration were washed with pure water, and 2H, 3H-decafluoropentane was volatilized and removed by increasing the temperature to 50 to 60° C. and then maintain for 30 minutes. The obtained dried coarse particles were pulverized by a pulverizer (RP-6-K115 manufactured by Rietz Manufacturing) to obtain a pulverized powder. The pulverized powder of the aggregates was sprayed and baked in a baking furnace described in Patent Document 3. The particles cooled below the melting point were collected and then used as first hot-melt fluorine resin particles 1. The average particle diameter of the obtained particles was d50: 31.4 μm. The volume resistivity of the particles 1 was measured in accordance with the evaluation method (7), and found to be 10⁵ to 10⁶ Ω·cm. The various evaluations described above were performed with the particles (powder) were used as a powder coating composition.

### Comparative Example 2

40.0 g of the first hot-melt fluorine resin particles 1 (average particle diameter d50: 31.4 μm) manufactured in the aforementioned preparation example and 60.0 g of a PFA powder coating (MJ-508 manufactured by Chemours-Mitsui Fluoroproducts Co., Ltd., Average particle diameter d50: 55.0 μm) as the second hot-melt fluorine resin were placed in a high-speed mixer (KSMAX manufactured by TANINAKA) and then mixed and stirred at 12,000 rpm for 30 seconds to obtain a powder coating composition.

### Example 1

20.0 g of the first hot-melt fluorine resin particles (average particle diameter d50: 31.4 μm) manufactured in the aforementioned preparation example 1, 79.4 g of a PFA powder coating (MJ-508 manufactured by Chemours-Mitsui Fluoroproducts Co., Ltd., Average particle diameter d50: 51.2 μm) as the second hot-melt fluorine resin, and 0.6 g of graphite were placed in a high-speed mixer (KSMAX manufactured by TANINAKA) and then mixed and stirred at 12,000 rpm for 30 seconds to obtain a powder coating composition.

### Example 2

A powder coating composition was obtained by a similar method as in Example 1 described above, except that 79.1 g of the PFA powder coating (second hot-melt fluorine resin) was used instead of 79.4 g, and 0.9 g of the graphite was used instead of 0.6 g.

### Preparation Example of First Hot-Melt Fluorine Resin Particles 2

First hot-melt fluorine resin particles 2 were manufactured by a similar method as in Comparative Example 1 (Preparation example of first hot-melt fluorine resin particles 1) described above, except that carbon black 1 was used instead of carbon black 2 (KETJENBLACK) and graphite. The average particle diameter of the obtained particles was d50: 22.2 μm. The volume resistivity of the particles 2 was measured in accordance with the evaluation method (7), and found to be 10¹² Ω·cm or more.

### Example 3

A powder coating composition was obtained by a similar method as in Example 2 described above, except that 20.0 g of the first hot-melt fluorine resin particles 2 (average particle diameter d50: 22.2 μm) manufactured in the aforementioned preparation example in place of the first hot-melt fluorine resin particles manufactured in preparation example 1 described above, and that a PFA powder coating (MJ-508 manufactured by Chemours-Mitsui Fluoroproducts Co., Ltd., Average particle diameter d50: 42.8 μm) was used as the second hot-melt fluorine resin.

### Example 4

A powder coating composition was obtained by a similar method as in Example 3 described above, except that 79.5 g of the PFA powder coating was used instead of 79.1 g, and 0.5 g of the graphite was used instead of 0.9 g.

### Example 5

A powder coating composition was obtained by a similar method as in Example 3 described above, except that 79.7 g of the PFA powder coating was used instead of 79.1 g, and 0.3 g of the graphite was used instead of 0.9 g.

### Results of Comparative Examples 1 and 2 and Examples 1 to 5

Tables 1 and 2 show composition ratios and coating film evaluation results of the powder coating compositions of Comparative Examples 1 and 2 and Examples 1 to 5. Table 1 summarizes the composition ratios of the powder coating compositions of the present invention. Table 2 shows the evaluation results measured in accordance with the evaluation methods (1) to (6). Comparative example 1 provided a coating film from the first hot-melt fluorine resin particles 1. However, (1) the coating appearance (uniform and no abnormalities with appearance: ∘), (2) the concealability (whether the substrate color is not visible: ∘), and (3) the thick coatability 1 (whether a 100 μm or thicker coating film can be formed by coating once on vertical surface: ∘) were sufficient, but (4) the thick coatability 2 (whether a 500 μm or thicker coating film can be formed by repeated coating: ∘) was not satisfied.

On the other hand, Comparative Example 2 provided a coating film obtained from the first hot-melt fluorine resin particles 1 and the second hot-melt fluorine resin particles. However, although (4) the thick coatability 2 (a 500 μm or thicker coating film is formed by repeated coating) was sufficient, items (1) to (3) were not satisfied.

In contrast, Examples 1 and 2, in which graphite is included as charge controlling agent particles serving as a third component in the powder coating composition of Comparative Example 2, achieved favorable results in all items (1) to (4). In Examples 3 to 5, the conductive particles to dispersed in the first hot-melt fluorine resin particles 2 were changed to carbon black 1 only, but the same favorable results obtained as with Examples 1 and 2, which include graphite and carbon black 2 (KETJENBLACK).

TABLE 1
Composition of Powder Coating Compositions of Comparative Examples 1 and 2
and Examples 1 to 5

| | | | Comparative | Comparative | Ex. | Ex. | Ex. | Ex. | Ex. |
|---|---|---|---|---|---|---|---|---|---|
| | | | Ex. 1 | Ex. 2 | 1 | 2 | 3 | 4 | 5 |
| First | Composition | PFA | 97.0 wt % | 97.0 wt % | 97.0 wt % | 97.0 wt % | 97.0 wt % | 97.0 wt % | 97.0 wt % |
| particles | | Graphite | 0.7 wt % | 0.7 wt % | 0.7 wt % | 0.7 wt % | | | |
| | | Carbon | 2.3 wt % | 2.3 wt % | 2.3 wt % | 2.3 wt % | | | |
| | | black 2 | | | | | | | |
| | | Carbon | | | | | 3.0 wt % | 3.0 wt % | 3.0 wt % |
| | | black 1 | | | | | | | |
| | Average particle | | 31.4 μm | 31.4 μm | 31.4 μm | 31.4 μm | 22.2 μm | 22.2 μm | 22.2 μm |
| | diameter d50 | | | | | | | | |
| | Mixing ratio (wt %) | | 100 | 40.0 | 20.0 | 20.0 | 20.0 | 20.0 | 20.0 |
| Second | Composition | PFA | | 97.0 wt % | 97.0 wt % | 97.0 wt % | 97.0 wt % | 97.0 wt % | 97.0 wt % |
| particles | | PPS | | 3.0 wt % | 3.0 wt % | 3.0 wt % | 3.0 wt % | 3.0 wt % | 3.0 wt % |
| | Average particle | | | 55.0 μm | 51.2 μm | 51.2 μm | 42.8 μm | 42.8 μm | 42.8 μm |
| | diameter d50 | | | | | | | | |
| | Mixing ratio (wt %) | | | 60.0 | 79.4 | 79.1 | 79.1 | 79.5 | 79.7 |
| Charge | Graphite | Mixing | | | 0.6 | 0.9 | 0.9 | 0.5 | 0.3 |
| controlling | | ratio | | | | | | | |
| agent | | (wt %) | | | | | | | |

TABLE 2
Evaluation Results of Comparative Examples 1 and 2 and Examples 1 to 5

| Evaluation | Evaluation | Comprarative | Comparative | Ex. | Ex. | Ex. | Ex. | Ex. |
|---|---|---|---|---|---|---|---|---|
| item | criteria | Ex. 1 | Ex. 2 | 1 | 2 | 3 | 4 | 5 |
| Coating | Uniformity | ○ | x | ○ | ○ | ○ | ○ | ○ |
| appearance | | | | | | | | |
| Concealability | Base | ○ | x | ○ | ○ | ○ | ○ | ○ |
| | color | | | | | | | |
| | Not | | | | | | | |
| | visible | | | | | | | |
| Thick | 100 μm | ○ | x | ○ | ○ | ○ | ○ | ○ |
| coatability 1 | coating | | | | | | | |
| | film | | | | | | | |
| | formed | | | | | | | |
| | on | | | | | | | |
| | vertical | | | | | | | |
| | surface | | | | | | | |
| Thick | 500 μm | x | ○ | ○ | ○ | ○ | ○ | ○ |
| coatability 2 | possible | | | | | | | |
| Conductivity | 100 μm | ○ | x | x | x | x | x | x |
| 1 | thick | (≤10⁶ Ω) | (>10¹² Ω) | (>10¹² Ω) | (>10¹² Ω) | (>10¹² Ω) | (>10¹² Ω) | (>10¹² Ω) |
| Conductivity | 300 μm | (Thick | x | x | x | x | x | x |
| 2 | thick | film | (10¹² Ω) | (>10¹² Ω) | (>10¹² Ω) | (>10¹² Ω) | (>10¹² Ω) | (>10¹² Ω) |
| | | formation: | | | | | | |
| | | NG) | | | | | | |

### Preparation Example of First Hot-Melt Fluorine Resin Particles 3

1000 g of pure water was collected in a 2 L stainless steel beaker, 18 g of carbon black 2 (KETJENBLACK) and 26 g of carbon fiber were added, and then an ultrasonic dispersion treatment was performed for five minutes using an ultrasonic generator (UE-100Z28S-8A Ultrasonic generator, manufactured by Ultrasonic Engineering Co., Ltd.). The obtained dispersion solution was added into a stainless steel container containing 4200 g of an PFA aqueous dispersion, and stirred at 600 rpm for 3 minutes using a downflow type propeller type 4-bladed stirrer. Then, 88 g of a 60% nitric acid aqueous solution was added thereto, and after confirming a rapid increase in viscosity, 1000 g of 2H, 3H-decafluoropentane was added to generate coarse particles of aggregates in the liquid. The coarse particles of the aggregate removed by filtration were washed with pure water, and 2H, 3H-decafluoropentane was volatilized and removed by increasing the temperature to 50 to 60° C. and then maintain for 30 minutes. The obtained dried coarse particles were pulverized by a pulverizer (RP-6-K115 manufactured by Rietz Manufacturing) to obtain a pulverized powder. The pulverized powder of the aggregates was sprayed and baked in a baking furnace described in Patent Document 3. The particles cooled below the melting point were collected and then used as first hot-melt fluorine resin particles 3. The average particle diameter of the obtained particles was d50: 17.6 μm. The volume resistivity of the particles 3 was measured in accordance with the evaluation method (7), and found to be 10⁵ to 10⁶ Ω·cm.

### Example 6

10.0 g of the first hot-melt fluorine resin particles 3 (average particle diameter d50: 17.6 μm) manufactured in the aforementioned preparation example, 89.1 g of a PFA powder coating (MJ-508 manufactured by Chemours-Mitsui Fluoroproducts Co., Ltd., Average particle diameter d50: 49.2 μm) as the second hot-melt fluorine resin particles, and 0.9 g of graphite were placed in a high-speed mixer (KSMAX manufactured by TANINAKA) and then mixed and stirred at 12,000 rpm for 30 seconds to obtain a powder coating composition.

### Example 7

A powder coating composition was obtained by a similar method as in Example 6, except that 20.0 g of the first hot-melt fluorine resin particles 3 was used instead of 10.0 and 79.1 g of the PFA powder coating (second hot-melt fluorine resin) was used instead of 89.1 g.

### Example 8

A powder coating composition was obtained by a similar method as in Example 6, except that 40.0 g of the first hot-melt fluorine resin particles 3 was used instead of 10.0 and 59.1 g of the PFA powder coating (second hot-melt fluorine resin) was used instead of 89.1 g.

### Preparation Example of First Hot-Melt Fluorine Resin Particles 4

First hot-melt fluorine resin particles 4 were manufactured by a similar method as in the preparation example of the first hot-melt fluorine resin particles 3, except that the amounts of the carbon black 2 and PFA aqueous dispersion were changed. The average particle diameter of the obtained particles was d50: 18.4 μm. The volume resistivity of the particles 4 was measured in accordance with the evaluation method (7), and found to be 10⁵ to 10⁶ Ω·cm.

### Example 9

A powder coating composition was obtained by a similar method as in Example 6, except that the first hot-melt fluorine resin particles 4 (average particle diameter d50: 18.4 μg) instead of the first hot-melt fluorine resin particles 3.

### Example 10

A powder coating composition was obtained by a similar method as in Example 7, except that the first hot-melt fluorine resin particles 4 (average particle diameter d50: 18.4 μg) instead of the first hot-melt fluorine resin particles 3.

### Example 11

A powder coating composition was obtained by a similar method as in Example 8, except that the first hot-melt fluorine resin particles 4 (average particle diameter d50: 18.4 μg) instead of the first hot-melt fluorine resin particles 3.

### Results of Examples 6 to 11

Tables 3 and 4 show composition ratios and coating film evaluation results of the powder coating compositions of Examples 6 to 11. Table 3 summarizes the composition ratios of the powder coating compositions of the present invention. Table 4 shows the evaluation results measured in accordance with the evaluation methods (1) to (6). Examples 6 to 11 use carbon black 2 (KETJENBLACK) and particles in which carbon fibers are dispersed as the first hot-melt fluorine resin particles 3. In Example 6, (1) for the thick coatability 1, it was confirmed that more than 2.8 g of coating can be applied without powder falling on the vertical surface and without causing electrostatic repulsion, and it was confirmed there was no abnormality in the coating film appearance. (2) For the thick coatability 2, a film having a thickness of 500 μm or more without foaming even after baking was obtained after the powder was electrodeposited and subjected to repeated coating and baking. (3) For the conductivity 1, a film with a thickness of approximately 100 μm exhibited a surface resistance value of 106 to 7Ω. (4) For the conductivity 2, a surface resistance value of 106 to 7Ω was exhibited in a film having a thickness of 300 μm or more. (5) For the coating film appearance, a smooth and uniform coating film was obtained. (6) For concealability, a coating film with a sufficiently concealed primer was obtained. As for Examples 7 to 11, favorable results were obtained in almost all items, similar to Example 6.

In Examples 6 to 11, as compared with Examples 1 to 5, by using the carbon black 2 (KETJENBLACK) and particles in which carbon fibers are dispersed as the first hot-melt fluorine resin particles, favorable conductivity of approximately 10⁶Ω was exhibited for both (5) the conductivity 1 (resistance value of a coating film of 100 μm) and (6) the conductivity 2 (resistance value of a coating film of 300 μm).

TABLE 3
Composition of Powder Coating Compositions of Examples 6 to 11

| | | | Ex. 6 | Ex. 7 | Ex. 8 | Ex. 9 | Ex. 10 | Ex. 11 |
|---|---|---|---|---|---|---|---|---|
| First | Composition | PFA | 96.6 wt % | 96.6 wt % | 96.6 wt % | 96.9 wt % | 96.9 wt % | 96.9 wt % |
| particles | | Graphite | | | | | | |
| | | Carbon | 1.4 wt % | 1.4 wt % | 1.4 wt % | 1.1 wt % | 1.1 wt % | 1.1 wt % |
| | | black 2 | | | | | | |
| | | Carbon | | | | | | |
| | | black 1 | | | | | | |
| | | Carbon | 2.0 wt % | 2.0 wt % | 2.0 wt % | 2.0 wt % | 2.0 wt % | 2.0 wt % |
| | | fiber | | | | | | |
| | Average particle | | 17.6 μm | 17.6 μm | 17.6 μm | 18.4 μm | 18.4 μm | 18.4 μm |
| | diameter d50 | | | | | | | |
| | Mixing ratio (wt %) | | 10.0 | 20.0 | 40.0 | 10.0 | 20.0 | 40.0 |
| Second | Composition | PFA | 97.0 wt % | 97.0 wt % | 97.0 wt % | 97.0 wt % | 97.0 wt % | 97.0 wt % |
| particles | | PPS | 3.0 wt % | 3.0 wt % | 3.0 wt % | 3.0 wt % | 3.0 wt % | 3.0 wt % |
| | Average particle | | 49.2 μm | 49.2 μm | 49.2 μm | 49.2 μm | 49.2 μm | 49.2 μm |
| | diameter d50 | | | | | | | |
| | Mixing ratio (wt %) | | 89.1 | 79.1 | 59.1 | 89.1 | 79.1 | 59.1 |
| Charge | Graphite | Mixing | 0.9 | 0.9 | 0.9 | 0.9 | 0.9 | 0.9 |
| controlling | | ratio | | | | | | |
| agent | | (wt %) | | | | | | |

TABLE 4
Evaluation Results of Examples 6 to 11

| Evaluation | Evaluation | | | | | Ex. | Ex. |
|---|---|---|---|---|---|---|---|
| item | criteria | Ex. 6 | Ex. 7 | Ex. 8 | Ex. 9 | 10 | 11 |
| Coating | Uniformity | ○ | ○ | ○ | ○ | ○ | ○ |
| appearance | | | | | | | |
| Concealability | Base | ○ | ○ | ○ | ○ | ○ | ○ |
| | color | | | | | | |
| | Not visible | | | | | | |
| Thick | 100 μm | ○ | ○ | ○ | ○ | ○ | ○ |
| coatability 1 | coating | | | | | | |
| | film | | | | | | |
| | formed on | | | | | | |
| | vertical | | | | | | |
| | surface | | | | | | |
| Thick | 500 μm | ○ | ○ | ○ | ○ | ○ | ○ |
| coatability 2 | possible | | | | | | |
| Conductivity | 100 μm | ○ | ○ | ○ | ○ | ○ | ○ |
| 1 | thick | (≤10⁶ Ω) | (≤10⁶ Ω) | (≤10⁶ Ω) | (≤10⁶ Ω) | (≤10⁶ Ω) | (≤10⁶ Ω) |
| Conductivity | 300 μm | ○ | ○ | | ○ | ○ | |
| 2 | thick | (≤10⁶ Ω) | (≤10⁶ Ω) | | (≤10⁶ Ω) | (≤10⁶ Ω) | |

### Preparation Example of First Hot-Melt Fluorine Resin Particles 5

First hot-melt fluorine resin particles 5 were manufactured by a similar method as in the preparation example of the first hot-melt fluorine resin particles 3, except that the amounts of the carbon black 2 and PFA aqueous dispersion were changed. The average particle diameter of the obtained particles was d50: 20.2 μm. The volume resistivity of the particles 5 was measured in accordance with the evaluation method (7), and found to be 10⁵ to 10⁶ Ω·cm.

### Example 12

A powder coating composition was obtained by a similar method as in Example 6, except that the first hot-melt fluorine resin particles 5 (average particle diameter d50: 20.2 μg) instead of the first hot-melt fluorine resin particles 3.

### Example 13

A powder coating composition was obtained by a similar method as in Example 7, except that the first hot-melt fluorine resin particles 5 (average particle diameter d50: 20.2 μg) instead of the first hot-melt fluorine resin particles 3.

### Example 14

A powder coating composition was obtained by a similar method as in Example 12, except that 30.0 g of the first hot-melt fluorine resin particles 5 (average particle diameter d50: 20.2 μm) was used instead of 10.0 and 69.1 g of the PFA powder coating (second hot-melt fluorine resin) was used instead of 89.1 g.

### Example 15

A powder coating composition was obtained by a similar method as in Example 8, except that the first hot-melt fluorine resin particles 5 (average particle diameter d50: 20.2 μg) instead of the first hot-melt fluorine resin particles 3.

### Example 16

A powder coating composition was obtained by a similar method as in Example 13, except that 78.65 g of the PFA powder coating (second hot-melt fluorine resin) was used instead of 79.1 g, and 1.35 g of the graphite was used instead of 0.9 g.

### Results of Examples 12 to 16

Tables 5 and 6 show composition ratios and coating film evaluation results of the powder coating compositions of Examples 12 to 16. Table 5 summarizes the composition ratios of the powder coating compositions of the present invention. Table 6 shows the evaluation results measured in accordance with the evaluation methods (1) to (6). For all of Examples 12 to 16, favorable results were obtained with respect to all the items of (1) coating appearance, (2) concealability, (3) thick coatability 1, (4) thick coatability 2, (5) conductivity 1, and (6) conductivity 2. However, with respect to (6) the conductivity 2, when the ratio of the first particles to the second particles was increased, the surface resistance showed a tendency to increase (an increasing tendency in Examples 12 to 15).

TABLE 5
Composition of Powder Coating Compositions of Examples 12 to 16

| | | | Ex. 12 | Ex. 13 | Ex. 14 | Ex. 15 | Ex. 16 |
|---|---|---|---|---|---|---|---|
| First | Composition | PFA | 97.2 wt % | 97.2 wt % | 97.2 wt % | 97.2 wt % | 97.2 wt % |
| particles | | Graphite | | | | | |
| | | Carbon | 0.8 wt % | 0.8 wt % | 0.8 wt % | 0.8 wt % | 0.8 wt % |
| | | black 2 | | | | | |
| | | Carbon | | | | | |
| | | black 1 | | | | | |
| | | Carbon | 2.0 wt % | 2.0 wt % | 2.0 wt % | 2.0 wt % | 2.0 wt % |
| | | fiber | | | | | |
| | Average particle | | 20.2 μm | 20.2 μm | 20.2 μm | 20.2 μm | 20.2 μm |
| | diameter d50 | | | | | | |
| | Mixing ratio (wt %) | | 10.0 | 20.0 | 30.0 | 40.0 | 20.0 |
| Second | Composition | PFA | 97.0 wt % | 97.0 wt % | 97.0 wt % | 97.0 wt % | 97.0 wt % |
| particles | | PPS | 3.0 wt % | 3.0 wt % | 3.0 wt % | 3.0 wt % | 3.0 wt % |
| | Average particle | | 49.2 μm | 49.2 μm | 49.2 μm | 49.2 μm | 49.2 μm |
| | diameter d50 | | | | | | |
| | Mixing ratio (wt %) | | 89.1 | 79.1 | 69.1 | 59.1 | 78.65 |
| Charge | Graphite | Mixing | 0.9 | 0.9 | 0.9 | 0.9 | 1.35 |
| controlling | | ratio | | | | | |
| agent | | (wt %) | | | | | |

TABLE 6
Evaluation Results of Examples 12 to 16

| Evaluation | Evaluation | | | | | |
|---|---|---|---|---|---|---|
| item | criteria | Ex. 12 | Ex. 13 | Ex. 14 | Ex. 15 | Ex. 16 |
| Coating | Uniformity | ○ | ○ | ○ | ○ | ○ |
| appearance | | | | | | |
| Concealability | Base color | ○ | ○ | ○ | ○ | ○ |
| | Not visible | | | | | |
| Thick | 100 μm | ○ | ○ | ○ | ○ | ○ |
| coatability 1 | coating film | | | | | |
| | formed on | | | | | |
| | vertical | | | | | |
| | surface | | | | | |
| Thick | 500 μm | ○ | ○ | ○ | ○ | ○ |
| coatability 2 | possible | | | | | |
| Conductivity 1 | 100 μm thick | ○ | ○ | ○ | ○ | ○ |
| | | (≤10⁶ Ω) | (≤10⁶ Ω) | (≤10⁷ Ω) | (≤10⁶ Ω) | (≤10⁶ Ω) |
| Conductivity 2 | 300 μm thick | ○ | ○ | ○ | ○ | ○ |
| | | (≤10⁶ Ω) | (≤10⁷ Ω) | (≤10⁹ Ω) | (≤10¹¹ Ω) | (≤10⁶ Ω) |

### Preparation Example of First Hot-Melt Fluorine Resin Particles 6

First hot-melt fluorine resin particles 6 (containing 5 wt % of SiC) were manufactured by a similar method as in the preparation example of the first hot-melt fluorine resin particles 2, except that SiC was used instead of the carbon black 1, and the amount thereof and the amount of the PFA aqueous dispersion were changed. The average particle diameter of the obtained particles was d50: 21.0 μm.

### Example 17

A powder coating composition (PFA powder coating: 79.7 wt %, Graphite: 0.3 wt %, Particles 6: 20.0 wt %) was obtained by a similar method as in Example 5, except that the first hot-melt fluorine resin particles 6 (average particle diameter d50: 21.0 μm) were used instead of the first hot-melt fluorine resin particles 2.

### Comparative Example 3

A powder coating composition (PFA powder coating: 80 wt %, Particles 6: 20 wt %) obtained in a similar method as in the aforementioned Example 17, except that the graphite was removed from the powder coating composition.

### Comparative Example 4

A powder coating composition was prepared from only the first hot-melt fluorine resin particles 6.

### Preparation Example of First Hot-Melt Fluorine Resin Particles 7

First hot-melt fluorine resin particles 7 (containing 1 wt % of mica) were manufactured by a similar method as in the preparation example of the first hot-melt fluorine resin particles 6, except that mica was used instead of SiC, and the amount thereof and the amount of the PFA aqueous dispersion were changed. The average particle diameter of the obtained particles was d50: 21.1 μm.

### Example 18

A powder coating composition (PFA powder coating: 79.7 wt %, Graphite: 0.3 wt %, Particles 7: 20 wt %) was obtained by a similar method as in Example 5, except that the first hot-melt fluorine resin particles 7 (average particle diameter d50: 21.1 μm) were used instead of the first hot-melt fluorine resin particles 2.

### Comparative Example 5

A powder coating composition (PFA powder coating: 80 wt %, Particles 7: 20 wt %) was obtained using a similar method as in the aforementioned Example 18, except that the graphite was removed from the powder coating composition.

### Comparative Example 6

A powder coating composition was prepared from only the first hot-melt fluorine resin particles 7.

### Results of Examples 17 and 18 and Comparative Example 3 to 6

Tables 7 and 8 show composition ratios and coating film evaluation results of the powder coating compositions of Examples 17 and 18 and Comparative Examples 3 to 6. Table 7 summarizes the composition ratios of the powder coating compositions of the present invention. Table 8 shows the evaluation results measured in accordance with the evaluation methods (1) to (3). From the results of Examples 17 and 18, it was confirmed that adding the graphite as a third component improved (1) the coating appearance, (2) the concealability, and (3) the thick coatability 1 in the same manner as when resin particles containing carbon black or the like were used, even when the first hot-melt fluorine resin particles containing a non-conductive filler such as SiC, mica, or the like were used. On the other hand, when graphite was not included as the third component (Comparative Examples 3 and 5), (1) the coating appearance was uneven and (2) the concealability was insufficient. Furthermore, when the powder coating composition was manufactured from only the hot-melt fluorine resin particles 6 and 7 (Comparative Examples 4 and 6), (1) the coating appearance and (2) the concealability were satisfied, but there was a problem with (3) the thick coatability 1.

TABLE 7
Composition of Powder Coating Compositions of Examples 17 and 18 and
Comparative Examples 3 to 6

| | | | Ex. | Comparative | Comparative | | Comparative | Comparative |
|---|---|---|---|---|---|---|---|---|
| | | | 17 | Ex. 3 | Ex. 4 | Ex. 18 | Ex. 5 | Ex. 6 |
| First | Composition | PFA | 95 wt % | 95 wt % | 95 wt % | 99 wt % | 99 wt % | 99 wt % |
| particles | | SiC | 5 w % | 5 w % | 5 w % | | | |
| | | Mica | | | | 1 w % | 1 w % | 1 w % |
| | Average particle | | 21.0 μm | 21.0 μm | 21.0 μm | 21.1 μm | 21.1 μm | 21.1 μm |
| | diameter d50 | | | | | | | |
| | Mixing ratio (wt %) | | 20.0 | 20.0 | 100 | 20.0 | 20.0 | 100 |
| Second | Composition | PFA | 97.0 wt % | 97.0 wt % | | 97.0 wt % | 97.0 wt % | |
| particles | Mixing ratio | PPS | 3.0 wt % | 3.0 wt % | | 3.0 wt % | 3.0 wt % | |
| | (wt %) | | | | | | | |
| | Average particle | | 49.2 μm | 49.2 μm | | 49.2 μm | 49.2 μm | |
| | diameter d50 | | | | | | | |
| | Mixing ratio (wt %) | | 79.7 | 80.0 | | 79.7 | 80.0 | |
| Charge | Graphite | Mixing | 0.3 | | | 0.3 | | |
| controlling | | ratio | | | | | | |
| agent | | (wt %) | | | | | | |

TABLE 8
Evaluation Results for Examples 17 and 18 and Comparative Examples 3 to 6

| Evaluation | Evaluation | Ex. | Comparative | Comparative | Ex. | Comparative | Comparative |
|---|---|---|---|---|---|---|---|
| item | criteria | 17 | Ex. 3 | Ex. 4 | 18 | Ex. 5 | Ex. 6 |
| Coating | Uniformity | ○ | x | ○ | ○ | x | ○ |
| appearance | | | | | | | |
| Concealability | Base | ○ | x | ○ | ○ | x | ○ |
| | color | | | | | | |
| | Not visible | | | | | | |
| Thick | 100 μm | ○ | ○ | x | ○ | ○ | x |
| coatability 1 | coating | | | | | | |
| | film | | | | | | |
| | formed on | | | | | | |
| | vertical | | | | | | |
| | surface | | | | | | |

The present invention is not limited to the disclosed content of the examples described in this specification or to the embodiments of the invention disclosed in this specification, and encompasses the content of inventions appropriately modified based on the particulars disclosed in this specification as long as the content does not conflict with the spirit of the present invention.

### INDUSTRIAL APPLICABILITY

The hot-melt fluorine resin powder coating composition of the present invention can be applied to a vertical surface by electrostatic powder coating, can form a relatively thick coating film on a wide range of industrial products and the like, and can provide properties (such as conductivity and the like) to the coating film via a filler included therein.

1. A powder coating composition, which is a powder mixture, comprising:
first hot-melt fluorine resin particles having an average particle diameter of 2 to 100 μm in which a filler is dispersed in the particles;
second hot-melt fluorine resin particles having an average particle diameter of 10 to 200 μm; and
charge controlling agent particles.

2. The powder coating composition according to claim 1, wherein the ratio of the first hot-melt fluorine resin particles to the second hot-melt fluorine resin particles is 1 to 60:40 to 99 wt %, and the amount of the charge controlling agent particles are in 0.01 to 5 wt % of the total amount of the powder coating composition.

3. The powder coating composition according to claim 1, wherein the average particle diameter of the second hot-melt fluorine resin particles is larger than the average particle diameter of the first hot-melt fluorine resin particles.

4. The powder coating composition according to claim 1, wherein the filler is a conductive filler.

5. The powder coating composition according to claim 4, wherein the conductive filler is a carbon material having a graphene structure.

6. The powder coating composition according to claim 1, wherein the charge controlling agent particles are graphite.

7. The powder coating composition according to claim 1, wherein the hot-melt fluorine resin is a perfluoro resin.

8. A coating film manufactured from the powder coating composition according to claim 1, wherein the film thickness is 100 μm or more.
